(19) United States
(12) Patent Application Publication
(10) Pub. No.: US 2008/0191116 A1
(43) Pub. Date: Aug. 14, 2008

(54) Two-Way Rolling Tree Stand with Support Collar

(76) Inventors: Erik Bornemeier, Bountiful, UT (US); Jared Hendricks, Draper, UT (US)

Correspondence Address: KIRTON & McCONKIE;A Professional Corporation, 1800 Eagle Gate Tower, 60 East South Temple Street, Salt Lake City, UT, 84111, US

(21) Appl. No.: 11/674,742

(22) Filed: Feb. 14, 2007

(51) Int. Cl. F16M 13/02

(52) U.S. Cl. 248/523; 16/18 R; 248/346.07; 248/430

(57) ABSTRACT

Embodiments of the present invention relate generally to tree stands that accommodate relocation and the like and, more particularly, to a circular base unit with casters which allow a stable rolling motion in combination with casters which allow a stable tilting motion and also including an inner support collar sleeve for providing additional support and preventing bending and damage to the tree's trunk during relocation.

### FIELD OF THE INVENTION

The present invention relates generally to tree stands that accommodate relocation of trees and, more particularly, to a rolling tree stand with casters which allow for a stable rolling motion while the tree is upright, in combination with a pair of elevated side wheel casters which allow for tilting the tree and a stable rolling motion while the tree is tilted, and also including an inner support collar sleeve for providing additional support and preventing bending and damage to the tree's trunk from excess pressure caused when the tree is tilted to one side.

### BACKGROUND

Artificial trees are widely used due to their durability, cost efficiency and consistent appearance. A well known occasion for use of artificial trees is the Christmas season wherein trees are customarily assembled, decorated and displayed in homes and businesses. Artificial trees are often constructed such that they can be shipped or stored in a disassembled state and assembled by the user at the desired location. At times it may be necessary to transport the tree from an installation location elsewhere, or in the case of a live-cut Christmas tree, for final removal of the tree. Prior art tree stands are stationary in nature and are not easily moved. In addition, the ceiling heights of many homes and offices today are 10 to 12 feet in height and higher while many doorways and other openings may be only 7 to 8 feet in height. The preferred height of a Christmas tree or other artificial tree is often the ceiling height. Consequently, there is a need for a tree stand which allows Christmas trees and other artificial trees to be tilted to one side and easily rolled through doorways and other openings which are shorter than the height of the assembled tree while remaining assembled and attached to their base to reduce or eliminate the time required for disassembly and reassembly.

### SUMMARY

It is an object of the present invention to provide an improved tree stand that accommodates relocation of a natural or artificial tree through a doorway or opening that is shorter than the tree. In accordance with this invention, an improved two-way rolling tree stand is provided which has a wide, stable base with integral, adjustable, and lockable rolling casters for rolling of a tree in an upright position as well as slightly elevated side wheel casters for tilting an attached tree and moving the tree in a tilted position through doorways and openings while maintaining stability and safety. Additionally, it is an object of the present invention to provide an improved tree stand that provides for an inner support collar that protects and supports the tree trunk from excess pressure caused by tipping the tree to the side when rolling the tree for relocation. The use of the present invention allows a tree to be moved in a quick, safe, easy and effective manner whether in an upright or tilted position. It will be understood that the present invention can be used to hold artificial trees or, alternatively, can be used with live-cut Christmas trees as well.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a is a top/side prospective view of an exemplary embodiment of the present invention comprising a rolling, tiltable tree stand with base casters and side wheel casters and a trunk support collar;

FIG. 2 is a is a top/side prospective view of an exemplary embodiment of the present invention comprising a tilted tree stand with base casters and side wheel casters and a trunk support collar;

FIG. 3 is a close-up view of an exemplary embodiment of the present invention comprising an inner support collar.

### DETAILED DESCRIPTION OF EXEMPLARY EMBODIMENTS

Embodiments of the present invention will be best understood by reference to the drawings, wherein like parts are designated by like numerals throughout. The figures listed above are expressly incorporated as part of this detailed description.

It will be readily understood that the components of the present invention, as generally described and illustrated in the figures herein, could be arranged and designed in a wide variety of different configurations. Thus, the following more detailed description of the embodiments of the methods and systems of the present invention is not intended to limit the scope of the invention but it is merely representative of the presently preferred embodiments of the invention.

Elements of embodiments of the present invention may be embodied in hardware, firmware and/or software. While exemplary embodiments revealed herein may only describe one of these forms, it is to be understood that one skilled in the art would be able to effectuate these elements in any of these forms while resting within the scope of the present invention.

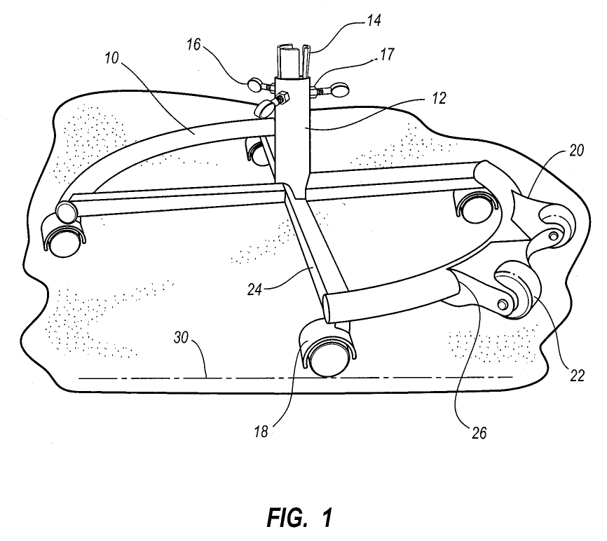

Some embodiments of the present invention, described with reference to FIG. 1, may comprise a base 10 manufactured from any rigid material, preferably metals, such as for example, aluminum, steel, stainless steel, etc. However, certain embodiments of the present invention may be manufactured from rigid plastics, rubber, woods, carbon composite material, or any variation thereof. Some embodiments may comprise crossing support members 24 to provide additional structural strength to the base 10. Some embodiments may further comprise, extending from the center of the base 10 and the crossing support members 24, a cylindrical trunk holder 12 with an inner support collar 14 for surrounding and supporting a tree trunk and a plurality of turn screws 16, wherein the plurality of turn screws may be inserted through a plurality of angularly spaced threaded nuts 17 attached to the cylindrical trunk holder 12 whereby the lower end portion of a tree trunk may be inserted through the inner support collar and into the cylindrical trunk holder. In some embodiments the turn screws 16 may be threaded through the threaded nuts 17 attached to the cylindrical trunk holder 12, by means of welding or some other method known in the art, and extend through the cylindrical trunk holder 12 whereby threaded advancement of the turn screws 16 may cause the end of the turn screws to push in on the clamping plates of the inner support collar 14 to tighten convergently around and compress tightly around the tree trunk, and thereby hold the tree trunk securely in place during movement while supporting and protecting the tree trunk from excess bending pressures. The circular base 10 may be provided with a plurality of rolling casters 18 which are integrally connected to the circular base 10 and are supported such that the vertical centers of all rolling casters 18 lie in one plane (not shown explicitly) when touching the ground and provide the rolling tree stand with safe, stable rolling movement in an upright position. In one embodiment a series of four casters 18 may be provided equidistant from each other around the perimeter of the circular base 10. Some embodiments of the present invention may comprise casters 18 which are adjustable and lockable, which may aid in keeping the tree stand stationary and stable when movement is not desired.

Some embodiments of the present invention comprise a planar base structure 10 to which is attached a series of casters 22 to maintain the tree in a vertical position for display or when moving in the vertical position. An angled support structure is attached to the planar base structure to provide support for the tree when tilted during movement through areas where the vertical movement of the tree would be awkward or prohibited. The angled support structure has attached to it a series of casters that contact the ground when the tree is tilted. These casters work in conjunction with some of the casters on the planar base structure to provide a stable moving platform for the tilted tree.

Some embodiments of the present invention may comprise a plurality of side wheel casters 22 supported by a plurality of side wheel caster supports 20 which allow for the rolling tree stand to be rolled in a tilted position, with some of the rolling casters 18 off (i.e. do not contact) the ground surface 30, while at least two of the rolling casters 18 and the side wheel casters 22 are in contact with the ground surface 30. In some embodiments the side wheel casters 22 may be mounted parallel to each other in a non-swivelling casterless manner. The side wheel caster supports 20 may be fixedly attached to the base 10 or may be attached in such a way as to allow for changes of the tilting angle. In some embodiments of the present invention the side wheel caster supports 20 may comprise a ratchet mechanism 26 which may allow the side wheel caster supports 20 to be adjusted to various tilt angles depending on the height of the tree being transported and the height of any openings the tree needs to pass through. Accordingly, the rolling, tiltable tree stand of the present invention has the versatility to be used for omnidirectional movement of a tree in an upright position and may be tilted and used for omnidirectional movement in a tilted position.

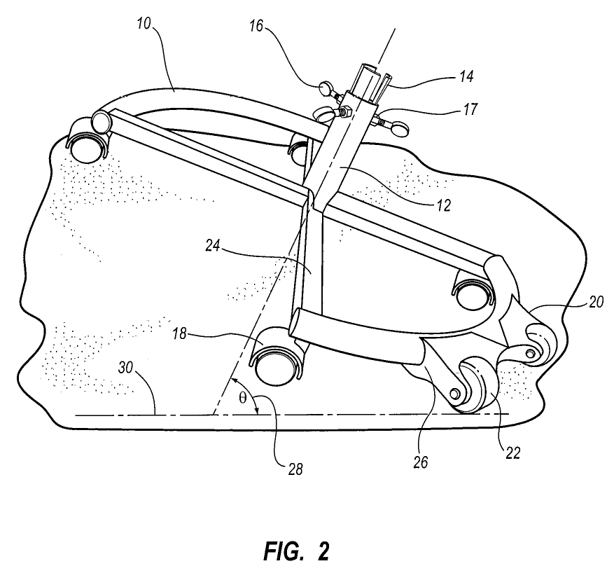

Some embodiments of the present invention, described with reference to FIG. 2, may comprise a substantially circular base 10, with crossing support members 24, a cylindrical trunk holder 12 with an inner support collar 14, a plurality of turn screws 16, wherein the plurality of turn screws may be inserted through a plurality of angularly spaced threaded nuts 17 attached to the cylindrical trunk holder 12 whereby the lower end portion of a tree trunk may be inserted through the inner support collar and into the cylindrical trunk holder. The circular base 10 may be provided with a plurality of rolling casters 18 which are integrally connected to the circular base 10 and are attached such that the vertical centers of all rolling casters 18 lie in one plane when the tree stand is in an upright position.

Some embodiments of the present invention may comprise a plurality of side wheel casters 22 supported by a plurality of side wheel caster supports 20. In some embodiments a series of two side wheel casters 22 may be provided attached to a side wheel caster support 20 integrally connected to circular base 10 which may extend out from and above the circular base 10 so as the two side wheel casters 22 are on a higher plane then the other plurality of rolling casters 18 so as to accommodate a tilting action. In some embodiments the side wheel caster supports 20 may be a single monolithic unit capable of supporting a plurality of side wheel casters. The side wheel caster supports 20 may be fixedly attached to the base 10 or may be attached in such a way as to allow for adjustments to the tilt angle theta 28. In some embodiments of the present invention the side wheel caster supports 20 may further comprise a ratchet mechanism 26 which may allow the side wheel caster supports 20 to be adjusted to various tilt angles depending on the height of the tree being transported and the height of any openings the tree may need to pass through. In some embodiments the ratchet mechanism may allow the tilt angle 28 to be adjusted in unlimited increments, single degree increments and in other embodiments the ratchet mechanism may allow the tilt angle 28 to be adjusted in 15 degree increments so that the tree may be tilted at an angle of 45 degrees, 60 degrees and 75 degrees from the level plane of the ground.

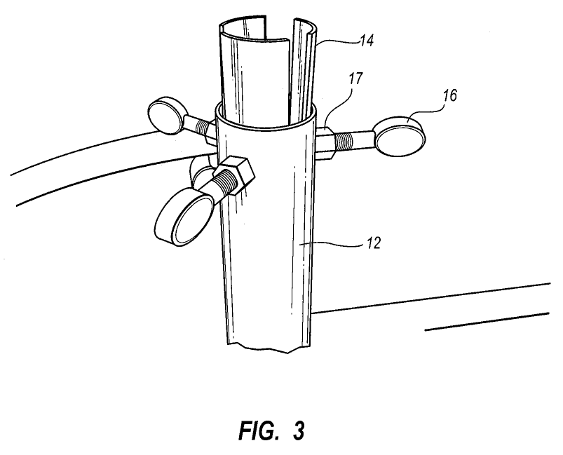

Some embodiments of the present invention, described with reference to FIG. 3, may comprise a cylindrical trunk holder 12 with an inner support collar 14 for surrounding and supporting a tree trunk, a plurality of turn screws 16, wherein the plurality of turn screws may be inserted through a plurality of angularly spaced threaded nuts 17 attached to the cylindrical trunk holder 12 by welding or other means whereby the lower end portion of a tree trunk may be inserted through the inner support collar and into the cylindrical trunk holder. In some embodiments the turn screws 16 may be threaded through the threaded nuts 17 which are attached to the cylindrical trunk holder 12, and extend through the cylindrical trunk holder 12 whereby threaded advancement of the turn screws 16 may cause the end of the turn screws to push in on the clamping plates of the inner support collar 14 to tighten convergently around and compress tightly around the tree trunk, and thereby hold the tree trunk securely in place while supporting and protecting the tree trunk from excess bending pressures which may occur during movement.

Some embodiments of the present invention may comprise a cylindrical trunk holder which is interchangeable with other cylindrical trunk holders of varying diameters so as to accommodate trees of varying trunk sizes. For example, in instances when the tree stand is to be used with live-cut Christmas trees a cylindrical trunk holder, designed for larger trunks, may be attached. In embodiments where a live-cut tree is to be used the cylindrical trunk holder may be designed to be water tight so that it may be filled with water. In some embodiments the cylindrical trunk holder may be sized with a diameter large enough to hold potted trees or large potted plants.

Embodiments of the present invention provide an improvement in tree stands and have the unique features of a circular base unit with casters which allow a stable rolling motion while a tree is rolled in an upright position in combination with side wheel casters which allow a stable tilting motion and a stable rolling motion while a tree is rolled in a tilted position and also including an inner support collar sleeve for providing additional support and preventing bending and damage to the tree's trunk during relocation.

The terms and expressions which have been employed in the foregoing specification are used therein as terms of description and not of limitation, and there is no intention in the use of such terms and expressions of excluding equivalence of the features shown and described or portions thereof, it being recognized that the scope of the invention is defined and limited only by the claims which follow.

What is claimed is:

1. A rolling tree support apparatus for transporting a tree comprising:
a base having a fixed planar structure and an angled structure;
a trunk holder extending perpendicularly from the planar structure of said base;
an inner support collar inserted into said trunk holder;
base caster wheels attached to the bottom of said planar base structure attached in a coplanar relationship in contact with the surface upon which the tree is being displayed;
side wheel casters connected to and extending outward from the angled structure of said base such that said tree support apparatus may be tilted onto said side wheel casters such that said side wheel casters come into contact with said surface such that said tree support apparatus is in a tilted position such that a tilt angle between said upright position and said tilted position allows said tree support apparatus to move the tree at a height less than the vertical height of the tree.

2. The apparatus of claim 1, further comprising castors capable of omnidirectional movement in an upright position or a tilted position.

3. The apparatus of claim 1, wherein said plurality of caster wheels are hooded twin wheel casters with polyurethane tires.

4. The apparatus of claim 1, wherein said plurality of adjustable side wheel caster supports is a single monolithic unit capable of supporting a plurality of side wheel casters.

5. The apparatus of claim 1 wherein said side wheel casters are mounted parallel to each other in a non-swivelling casterless manner.

6. The apparatus of claim 1 wherein said tilt angle between said upright position and said tilted position is 45 degrees from said ground surface.

7. The apparatus of claim 1 wherein said tilt angle between said upright position and said tilted position is 60 degrees from said ground surface.

8. The apparatus of claim 1 wherein said tilt angle between said upright position and said tilted position is 75 degrees from said ground surface.

9. The apparatus of claim 1, wherein said plurality of caster wheels are lockable.

10. The apparatus of claim 1, wherein said cylindrical trunk holder is interchangeable with other cylindrical trunk holders capable of holding trunks with diameters from 2 to 4 inches.

11. The apparatus of claim 1, wherein said cylindrical trunk holder is interchangeable with other cylindrical trunk holders capable of holding trunks with diameters from 4 to 6 inches.

12. The apparatus of claim 1, wherein said cylindrical trunk holder is interchangeable with other cylindrical trunk holders capable of holding a potted plant or potted tree on said apparatus when said apparatus is moved.

13. A rolling tree support apparatus for transporting a tree comprising: an integrally formed substantially circular base with cross bracing, a plurality of caster wheels attached to the bottom of said base and supported in a substantially coplanar relationship to other caster wheels of said plurality of caster wheels; a plurality of adjustable side wheel caster supports connected to and extending outward from said base, a plurality of side wheel casters supported by said plurality of adjustable side wheel caster supports; and
a cylindrical trunk holder with an inner support collar, said inner support collar comprising a plurality of clamping plates positioned in a generally cylindrical formation within said cylindrical trunk holder for surrounding a tree trunk, with each clamping plate being compressed tightly around said tree trunk by an end of one of a plurality of turn screws, wherein said plurality of turn screws are inserted through a plurality of angularly spaced threaded nuts attached to said cylindrical trunk holder whereby the lower end portion of a tree trunk is inserted through said inner support collar and into said cylindrical trunk holder; said plurality of turn screws are threaded through said plurality of threaded nuts attached to said cylindrical trunk holder and extend through said cylindrical trunk holder whereby threaded advancement of said turn screws causes said clamping plates to tighten convergently upon said tree trunk.

14. The apparatus of claim 12, wherein said plurality of clamping plates is a single cylindrical clamping plate with a plurality of compression slots.

15. The apparatus of claim 12, wherein said cylindrical trunk holder is interchangeable with other cylindrical trunk holders capable of holding trunks with diameters from 2 to 4 inches.

16. The apparatus of claim 12, wherein said cylindrical trunk holder is interchangeable with other cylindrical trunk holders capable of holding trunks with diameters from 4 to 6 inches.

17. The apparatus of claim 12, wherein said cylindrical trunk holder is watertight and rustproof.

18. The apparatus of claim 12, wherein said cylindrical trunk holder is interchangeable with other cylindrical trunk holders capable of holding a potted plant or potted tree on said apparatus when said apparatus is moved.
